(19) United States
(12) Patent Application Publication
(10) Pub. No.: US 2014/0281129 A1
(43) Pub. Date: Sep. 18, 2014

(54) DATA TAG SHARING FROM HOST TO STORAGE SYSTEMS

(71) Applicants: Tal Heller, Aloney Abba (IL); Yuval Kenan, Rehovot (IL); Yacov Duzly, Raanana (IL); Nir Perry, Holon (IL)

(72) Inventors: Tal Heller, Aloney Abba (IL); Yuval Kenan, Rehovot (IL); Yacov Duzly, Raanana (IL); Nir Perry, Holon (IL)

(21) Appl. No.: 13/834,282

(22) Filed: Mar. 15, 2013

(51) Int. Cl. G06F 12/00

(52) U.S. Cl. CPC G06F 12/00
USPC 711/103; 711/154; 711/162

(57) ABSTRACT

A system and method for data tag sharing is disclosed. A host system may provide a storage system with information that identifies a set of logical addresses as pointing to data that is cold, which may mean that the data has not been written to within a threshold time period, such as a year. The storage system may process the data stored at physical locations corresponding to the set of logical addresses as cold data based on receipt of the information from the host system.

### BACKGROUND

1. Technical Field

This application relates to storage systems and, in particular, to cold data.

2. Related Art

A storage system, such as a flash drive, may read and write data at the direction of a host system, such as a laptop or tablet computer. For example, the host system may send the data and a logical address for the data to the storage system. The storage system may map the logical address to a physical location in the storage system and store the data at the physical location. The host system may later send the logical address to the storage system in a read request. In response to the read request, the storage system may map the logical address to the physical location, and return the data read from the physical location.

Some of the data that is stored in the storage system may become cold over time. Cold data may be data that has not been written or updated within a threshold time period, such a 30 day period, a year, or some other time frame.

### SUMMARY

In order to obtain and use identification of cold data stored in a storage system, a system and method for data tag sharing is disclosed. The data tag sharing system and method may obtain one or advantages from the identification of the cold data, such as an increase in performance, a decrease in cost, and/or an increase in storage capacity.

According to one aspect, a storage system is disclosed. The storage system may include a storage memory. Physical locations in the storage memory correspond to logical addresses, where data identified by a logical address is stored at a corresponding physical location in the storage memory, where the logical addresses is included in the logical addresses, and where the corresponding physical location is included in the physical locations. The storage system may further include a storage interface configured to receive information from a host system that indicates the data identified by the logical address is cold. The data is cold if the data has not been written within a threshold time period. The storage system may further include a storage controller configured to process the data stored in the corresponding physical location as cold data in response to receipt of the information from the host system that indicates the data identified by the logical address is cold.

According to another aspect, a computer-readable storage medium is disclosed. The computer-readable storage medium is encoded with computer executable instructions that are executable with a processor. When the instructions are executed, a set of files stored in a storage system that have a last modified date older than a threshold time period may be identified. The set of files may be mapped to logical addresses that point to data belonging to the set of files in the storage system. A command may be transmitted from a host system to the storage system, where the command identifies the logical addresses that point to cold data on the storage system. The cold data is data that has not been written to within the threshold time period.

In yet another aspect, a data tag sharing method is disclosed. A storage memory may be provided in a storage system. Physical locations in the storage memory correspond to logical addresses. Data stored at a physical location in the storage memory is pointed to by a logical address. The physical location is included in the physical locations, and the logical address is included in the logical addresses. A command may be received over a storage interface where the command identifies the logical address as pointing to data that has not been updated within a threshold time period. The data stored at the physical location may be processed as cold data with a storage controller based on receipt of the command over the storage interface, where the command identifies the logical address that points to the data.

Further objects and advantages of the present disclosure will be apparent from the following description, reference being made to the accompanying drawings.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a data tag sharing system;

FIG. 2 illustrates a flow diagram of a host system that identifies cold data for a storage system;

FIG. 3 illustrates a flow diagram of a storage system processing identified cold data using different memory types;

FIG. 4 illustrates a flow diagram of a storage system processing identified cold data using compression; and

FIG. 5 illustrates a flow diagram of logic of a data tag sharing system.

### DETAILED DESCRIPTION

FIG. 1 illustrates a data tag sharing system 100. The data tag sharing system 100 may include a storage system 102 and a host system 104.

The storage system 102 may be device or combination of devices that stores data. For example, the storage system 102 may be a block device that comprises a device or combination of devices providing block level access to the data. A block device provides block level access by reading and writing data in the form of blocks. Examples of the storage system 102 may include a flash drive, a solid state drive, a hard drive, a storage area network (SAN), or any other read/writeable computer-readable storage medium. The storage system 102 may be in different forms, for example in the form of a portable memory card that may be carried between host devices or, for example, as a solid state disk (SSD) embedded in the host system 104. Alternatively, the storage system 102 may be a discrete storage device physically separate from the host system 104 even when the storage system 102 is in communication with the host system 104. The storage system 102 may communicate with the host system 104 through a mechanical and electrical connector, such as a connector 103, or wirelessly, using any of a number of wired or wireless interfaces.

The storage system 102 may include a storage interface 105, a storage controller 106, and storage memory, such as a first memory 108 and a second memory 110. The storage system 102 may include a logical-to-physical map 112 and a cache 114.

The storage interface 105 may be any hardware configured to receive data from the host system 104. The storage interface 105 may be a Serial Advanced Technology Attachment (also known as a Serial ATA or SATA) interface, a SCSI (Small Computer System Interface), or any other type of storage interface.

The storage memory 108 or 110 may be any hardware component that stores data that may be read and written by a processor such as the storage controller 106. The storage memory 108 or 110 may be non-volatile memory, such as flash memory, and/or volatile memory, such as a random access memory (RAM). Alternatively or in addition, the storage memory 108 or 110 may be or include an optical, magnetic (hard-drive) or any other form of data storage device.

The first storage memory 108 may be a different type of memory than the second storage memory 110. For example, the first storage memory 108 may be NAND flash memory and the second storage memory 110 may be NOR flash memory. In another example, the first storage memory 108 may be single level cell (SLC) flash memory, and the second storage memory 110 may be multi-level cell (MLC) flash memory.

The storage controller 106 may be any hardware or combination of hardware and software that translates logical addresses 116, such as logical block addresses (LBAs), which are received from the host 104, into appropriate signaling to access corresponding physical locations 118, such as sectors, of the storage memory 108 or 110. Examples of the storage controller 106 may include a memory controller, a NAND controller, a NOR controller, a disk controller, a SCSI (Small Computer System Interface) controller, a Fibre Channel controller, an INFINIBAND® controller (INFINIBAND is a registered trademark of System I/O, Inc. of Beaverton, Oreg.), a Serial Attached SCSI controller, a PATA (IDE) controller, and a Serial ATA controller.

The logical addresses 116 may be any address of a storage object, such as a logical block stored in a block device or any other unit of storage in the storage system 102 that is externally addressable. The physical locations 118 may be any physical portion of the storage memory 108 and 110 that may be addressable within the storage system 102.

The logical-to-physical map 112 may be a data structure, such as a table, and/or a module, such as a lookup module, that determines and/or stores a mapping between the logical addresses 116 and the physical locations 118. The logical-to-physical map 112 may be included in the storage memory 108 and 110 or in some other memory.

The cache 114 may be memory for temporary storage. The cache 114 may be included in the storage memory 108 or 110 or in some other memory.

The host system 104 may be device or combination of devices that accesses data in the storage system 100. Examples of the host system 104 may include a computer, a server, a laptop, a mobile device, a cell phone, a tablet computer, a notebook, a netbook, or any other computing device.

The host system 104 may include a processor 120, a memory 122, and a host controller 124. The memory 122 may include modules, such as a block device driver 126, a files system module 128, and an application 130.

The memory 122 of the host system 104 may be any device that stores data readable by the processor 120. The memory 122 may include non-volatile and/or volatile memory, such as a random access memory (RAM), a read-only memory (ROM), an erasable programmable read-only memory (EPROM), or flash memory. Alternatively or in addition, the memory 122 of the host system 104 may include an optical, magnetic (hard-drive) or any other form of data storage device.

The processor 120 may be one or more devices operable to execute instructions or computer code embodied in the memory 122, or in other memory of the host system 104, to perform the features of the modules including the block device driver 126, the files system module 128, and the application 130. The computer code may include instructions executable with the processor 120. Examples of the process may include a general processor, a central processing unit, a server device, an application specific integrated circuit (ASIC), a digital signal processor, a field programmable gate array (FPGA), a digital circuit, an analog circuit, a microcontroller, any other type of processor, or any combination thereof.

The host controller 124 may be hardware or a combination of hardware and software that handles communication between the host system 104 and the storage system 102 on behalf of the host system 104. For example, the host controller 124 may communicate with the storage controller 106 in the storage system 102 over the connector 103 or other type of communication channel.

The block device driver 126 may be a module that provides an abstraction layer that converts generic read and write requests to requests that may be specific to the storage system 102. The read and write requests may target one or more logical addresses 116 of data in the storage system 102.

The file system module 128 may provide an abstraction layer for storing, retrieving, and updating files of a file system. The file system module 128 may convert file operations to block level operations that are completed via the block device driver 126. A file may be mapped to a one or more of the logical addresses 116 that contain the data for the file. The file system 128 module may maintain a file-to-logical block map 134 that maps each file in the file system to a corresponding subset of the logical addresses 116 that contain the data of each file. The file-to-logical block map 134 may be stored in the storage system 102 or in some other memory.

The application 130 may be any application that uses the file system. The application 130 may execute in an operating system for example. The application 130 may access files stored on the storage system 102 via the file system module 128.

During operation of the data tag sharing system 100, the host system 104 may identify a set of the logical addresses 116 that point to cold data. Cold data may be data that has not been written within a threshold time period, For example, if the data has not been initially stored or subsequently updated longer than the threshold time period ago, then the data may be considered cold. The threshold time period may vary. The threshold time period may be configured by a user. Alternatively or in addition, the threshold time period may be dynamically determined based on one or more factors, such as the r types of the storage memory 108 and 110 in the storage system 102. The threshold time period may be any period of time, such as seven days, 30 days, a year, or any other length of time.

The host system 104 may transmit information 136 that identifies cold data to the storage system 102. For example, the information 136 transmitted to the storage system 102 may identify the set of logical addresses 116 that point to cold data. The information 136 transmitted may be in the form of a “mark cold” command or aging command. The aging command may be any command that identifies data stored in the storage system 102 as cold. The aging command may be a command that is part of a storage protocol. For example, the aging command may be a SCSI command, an SD command, an eMMC command, or a command in any other storage protocol.

The storage protocol may be any communications protocol used to provide block level access to a block storage device or system, such as the storage system 102, from a host system, such as the host system 104. The storage protocol may be implemented, for example, using one or more controllers, such as the storage controller 106 and/or the host controller 124. The storage protocol and electrical characteristics of the controller may be part of a common standard. In one example, the storage protocol may be the universal serial bus mass storage device class (USB MSC or UMS), which is a set of computing communications protocols defined by the USB Implementers Forum that runs on a hardware bus, such as the connector 103, that conforms to the USB standard. In a second example, the storage protocol may be the SCSI command protocol. In a third example, the storage protocol may be the SATA protocol. Additional examples of the storage protocol include embedded MultiMediaCard (eMMC), secure digital (SD), Serial Attached SCSI (SAS) and Internet Small Computer System Interface (iSCSI). Alternatively or in addition, the block device driver 126 may provide block-level access using any storage protocol that transfers data with a data transfer protocol, such as SCSI over Fibre Channel, SCSI RDMA Protocol (SRP) over Remote Direct Memory Access (RDMA), iSCSI over TCP/IP, or any other combination of storage protocol or data transfer protocol.

The information 136 identifying the cold data may be considered to “tag” the identified data as cold data. The transmission of the information 136 from the host system 104 to the storage system 102 shares the data tagging.

The storage system 102 may receive the information 136 that identifies the cold data over the storage interface 105. Based on receipt of the information 136 over the storage interface 105, the storage controller 106 may process the data identified in the information 136 received as cold data. The storage controller 106 may process the identified data as cold data in many ways described later below.

Turning first to the host system 104, the host system 104 may identify cold data and share that information 136 with the storage system 102 using many mechanisms. For example, FIG. 2 illustrates a flow diagram of one mechanism in which the host system 104 may identify cold data for the storage system 102. The application 130, the file system module 128, or a combination thereof may implement the mechanism.

In a first operation, a list of files that are in the file system may be created (210). The list may be traversed by sequentially selecting the next file in the list (220).

A determination may be made whether the selected file contains cold data (230). For example, if last modified date of the selected file indicates that the file was last written to longer ago than the threshold period, then the file may be considered cold.

If the selected file is not cold and a determination is made that more files are left in the list of files (240), then operations may return to selecting the next file in the list (220). If the selected file is not cold and no more files are left in the list of files, then operations may end.

However, if the selected file is cold, then the logical address or addresses 116 that belong to the selected file may be identified (250). For example, the files system module 128 may identify the logical address 116 that belong to the selected file using the file-to-logical address map 134.

Next, the identity of the logical address or addresses 116 that belong to the selected file may be included in the information 136 identifying cold data that is transmitted to the storage system 102 (260). For example, a set of LBAs belonging to the file may be included in the “Mark Cold” command and the command may be transmitted from the host system 104 to the storage system 104.

A determination is made whether more files are left in the list of files (240). If more files are left in the list of files (240), then operations may return to selecting the next file in the list (220). If no more files are left in the list of files (240), then operations may end.

In mechanisms different from the one illustrated in FIG. 2, the list of files may be created to only include those files that were last updated longer ago than the threshold time period. Alternatively or in addition, a complete set of the logical addresses 116 that point to cold data may be derived from the entire list of files, and the complete set of the logical addresses 116 may be transmitted from the host system 104 to the storage system 102 in one command or in a determined number of commands.

With respect to the storage system 102, the storage controller 106 may process the identified data as cold data in many ways. For example, FIG. 3 illustrates a flow diagram of the storage system 102 processing the identified data using different memory types.

The storage system 102 may take advantage of different types of memory having different characteristics, some of which may be better suited for storage of cold data than others. For example, the first storage memory 108 may include single level cell (SLC) flash memory, and the second storage memory 110 may include multi-level cell (MLC) flash memory. Flash memory generally provides highest performance when the number of data bits per cell is lowest, such as binary flash, also known as single level cell (SLC) flash, which stores 1 bit per cell. Flash memory that is configured to store more than one bit per cell, known as multi-level cell (MLC) flash, can store 2 or more bits of information per cell. While SLC flash memory is generally known for having better read and write performance (for example, speed and endurance) than MLC flash, MLC flash provides more storage capacity and is generally less expensive to produce. The endurance and performance of MLC flash tends to decrease as the number of bits per cell of a given MLC configuration increases. Accordingly, the second storage memory 210 that includes the MLC flash memory may be better suited to store cold data than the first storage memory 108 that includes SLC flash memory. Conversely, the first storage memory 108 that includes SLC flash memory may be better suited to store transient data than the second storage memory 110 that includes MLC flash memory. As another example, the first storage memory 108 may include X2 flash memory, which has a two bit per cell capacity, and the second storage memory 110 may include eX3 flash memory, which has a three bit per cell capacity, or Bit Cost Scalable (BiCS) flash memory.

By moving cold data from one type of flash memory to another within the storage system 102, the storage system 102 may realize a number of advantages, such as increasing the total number of free blocks and/or achieving a better tradeoff between cost and performance. Some flash management types (page-base or chunk-base systems) may be based on an assumption that “media is almost empty”. The performance of such flash management types may depend on the number of free blocks in the storage memory 108. Moving cold data out of the first storage memory 108 that may be controlled using such flash management types may increase performance. In addition, more free blocks may result in less garbage collection, which may result in higher write performance (random and sequential). Costs may be decreased by copying the cold data to low cost memories that may have write performance that adequate for cold data, but not good enough for data accessed more frequently.

In a first operation illustrated in FIG. 3, the information 136 identifying cold data may be received (310) over the storage interface 106 from the host system 104. For example, the “Mark Cold” command may be received that identifies a set of the logical addresses 116 that point to the cold data.

Next, the storage controller 106 may determine that the set of the logical addresses 116 point to a set of the physical locations 118 in the first storage memory 108, and, accordingly, allocate (320) a corresponding set of the physical locations 118 in the second storage memory 110. The storage controller 106 may determine the corresponding set of the physical locations 118 in the second storage memory 110 from a set of the physical locations 118 in the second storage memory 110 that are currently free or unallocated.

The storage controller 106 may copy (330) the cold data from the set of the physical locations 118 in the first storage memory 108 to the corresponding set of the physical locations 118 in the second storage memory 110. The storage controller 106 may update (340) the logical-to-physical map 112 so that the set of the logical addresses 116 point to the corresponding set of the physical locations 118 in the second storage memory 110. The storage controller 106 may release (350) the set of the physical locations 118 in the first storage memory 108

The storage controller 106 may allocate (320) the corresponding set of the physical locations 118, copy (330) the cold data, update (34) the logical-to-physical map 112, and release (350) the set of the physical locations 118 in the first storage memory 108 immediately, during idle time, or at any other time in response to receipt of the information 136 identifying the cold data.

Another example of how the storage system 102 may process the information 136 identifying cold data involves the storage system 102 compressing the cold data. By compressing the cold data, the storage system 102 may increase the total storage capacity of the storage system 102 without suffering a decrease in throughput performance associated with compression when accessing data that is not cold. FIG. 4 illustrates a flow diagram of the storage system 102 processing the identified cold data using compression.

In a first operation, the information 136 identifying cold data may be received (410) over the storage interface 106 from the host system 104. For example, the “Mark Cold” command may be received that identifies a set of the logical addresses 116 that point to the cold data.

Next, the storage controller 106 may copy (420) the cold data from a first set of the physical locations 118 of the storage memory 108 or 110, which correspond to the set of the logical addresses 116, to the cache 114. The storage controller 106 may identify the first set of the physical locations 118 from the set of the logical addresses 116 based on the logical-to-physical map 112.

The storage controller 106 may compress (430) the cold data in the cache 114. The storage controller 106 may copy (440) the compressed cold data from the cache 114 to a second set of the physical locations 118 of the storage memory 108 or 110.

The storage controller 106 may update (450) the logical-to-physical map 112 so that the set of the logical addresses 116 point to the second set of the physical locations 118 in the storage memory 108 or 110. The storage controller 106 may release (469) the first set of the physical locations 118 in the storage memory 108 or 110.

The mechanism illustrated in FIG. 4 may be used in conjunction with the mechanism illustrated in FIG. 3. For example, the cold data may be compressed as it is moved from the first storage memory 108 to the second storage memory 110. Alternatively, the storage memory 108 or 110 may include one memory and the uncompressed cold data may be located in a first set of the physical locations 118 and the compressed cold data may be relocated in the one memory to a second set of the physical locations 118.

Yet another example of the storage system 102 processing the information 136 that identifies cold data includes the storage system 102 increasing data retention characteristics of the physical locations 118 in the storage memory 108 or 110 at which the cold data is stored. For example, the storage controller 106 may narrow the distribution of voltages around each state in cells that are included at the physical locations 118 of flash memory included in the storage memory 108 or 110 that store the cold data. Narrowing the distribution of the voltages may result in increasing the data retention times of the physical locations 118 that store the cold data. To narrow the distribution of the voltages, the storage controller 106 may set a portion of the storage memory 108 or 110 to have a slow programming speed instead of a fast programming speed. The portion of the storage memory 108 or 110 configured with the slow programming speed may have slower write times than a portion configured with the fast programming speed. However, the slower write times may not be an issue for cold data. The mechanism of increasing the data retention characteristics of the physical locations 118 may be used together with other mechanisms that leverage the identification of the cold data. Alternatively, the mechanism of increasing the data retention characteristics may be used without using any other mechanisms that leverage the identification of the cold data.

FIG. 5 illustrates a flow diagram of logic of the data tag sharing system 100. The logic may include additional, different, or fewer operations. The operations may be executed in a different order than illustrated in FIG. 5.

The storage memory 108 and 110 may be provided (510) in the storage system 102. For example, the storage memory 108 and 110 may be made accessible by the host system 104. The physical locations 118 in the storage memory 108 and 110 may correspond to the logical addresses 116, where data stored at a physical location in the storage memory 108 and 110 is pointed to by a logical address, wherein the physical location is included in the physical locations 118, and wherein the logical address is included in the logical addresses 116.

The aging command may be received (520) over the storage interface 105, where the aging command identifies the logical address as pointing to data that has not been updated within a threshold time period.

The data stored at the physical location may be processed as cold data with the storage controller 106 based on receipt of the aging command over the storage interface 105 that identifies the logical address that points to the data.

The data tag sharing system 100 may be implemented with additional, different, or fewer components. For example, the data tag sharing system 100 may include the storage system 102 but not the host system 104. Instead, the data tag sharing system 100 may communicate with the host system 104. Alternatively, the data tag sharing system 100 may include the host system 104 but not the storage system 102. Instead, the data tag sharing system 100 may communicate with the storage system 102.

Each component may include additional, different, or fewer components. For example, the host system 104 may not include the application 130. In another example, the host system 104 may include a display device. In third example, the storage system 102 may include multiple storage controllers. In a fourth example, the storage system 102 may not include the cache 114. In a fifth example, the storage system 102 may include just one storage memory 108 or 110. In a six example, the storage system 102 may include three or more storage memories 108 and 110.

The logic illustrated in each of the flow diagrams may include additional, different, or fewer operations. The operations in each of the flow diagrams may be executed in a different order than illustrated.

The data tag sharing system 100 may be implemented in many different ways. Each module, such as the application 130, the file system module 128, and the block device driver 126, is implemented in hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of the memory 122, for example, that comprises instructions executable with the processor 120 or other processor to implement one or more of the features of the module. When any one of the module includes the portion of the memory that comprises instructions executable with the processor, the module may or may not include the processor. In some examples, each module may just be the portion of the memory 122 or other physical memory that comprises instructions executable with the processor 120 or other processor to implement the features of the corresponding module without the module including any other hardware. Because each module includes at least some hardware even when the included hardware comprises software, each module may be interchangeably referred to as a hardware module, such as the application hardware 130, the file system hardware module 128, and the block device driver hardware 126.

The storage memory 108 and 110 may include two different types of flash memory using any number of techniques. For example, the second storage memory 110 may be included on a die that is physically separate from a die that includes the first storage memory 108, such as in Bit Cost Scalable (BiCS) flash memory. In another example, an X2 block may be programmed to be an X3 block. In yet another example, the first storage memory 108 may be a first memory chip and the second storage memory 110 may be a second memory chip that is physically distinct from the first memory chip.

Although some features are shown stored in computer-readable memories (e.g., as logic implemented as computer-executable instructions or as data structures in memory), all or part of the system and its logic and data structures may be stored on, distributed across, or read from other types of machine-readable storage media. The computer-readable storage media may include memories, hard disks, floppy disks, CD-ROMs, or any other type of storage medium or storage media.

The processing capability of the data tag sharing system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (e.g., a dynamic link library (DLL)). The DLL, for example, may implement the features of a software portion of the block device driver 126.

All of the discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other computer-readable storage media, for example, secondary storage devices such as hard disks, floppy disks, and CD-ROMs; or other forms of ROM or RAM. The computer-readable storage media may be non-transitory computer-readable media, which includes CD-ROMs, volatile or non-volatile memory such as ROM and RAM, or any other suitable storage device. Moreover, the various modules and screen display functionality is but one example of such functionality and any other configurations encompassing similar functionality are possible.

The respective logic, software or instructions for implementing the processes, methods and/or techniques discussed above may be provided on computer-readable media or memories or other tangible media, such as a cache, buffer, RAM, removable media, hard drive, other computer readable storage media, or any other tangible media or any combination thereof. The tangible media include various types of volatile and nonvolatile storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

Furthermore, although specific components are described above, methods, systems, and articles of manufacture consistent with the innovation may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

What is claimed is:

1. A storage system comprising:
a storage memory, wherein physical locations in the storage memory correspond to logical addresses, wherein data identified by a logical address is stored at a corresponding physical location in the storage memory, wherein the logical addresses is included in the logical addresses, and wherein the corresponding physical location is included in the physical locations;
a storage interface configured to receive information from a host system that indicates the data identified by the logical address is cold, wherein the data is cold if the data has not been written within a threshold time period; and
a storage controller configured to process the data stored in the corresponding physical location as cold data in response to receipt of the information from the host system that indicates the data identified by the logical address is cold.

2. The storage system of claim 1, wherein the information received from the host includes a mark cold command comprising a set of logical block addresses that identify cold data, the set of logical block addresses including the logical address.

3. The storage system of claim 1, wherein the storage controller is configured to process the data identified by the logical address as cold data through a transfer of the data from a first storage memory to a second storage memory, and wherein the first storage memory and the second storage memory are included in the storage memory.

4. The storage system of claim 3, wherein the second storage memory includes a different type of memory than the first storage memory.

5. The storage system of claim 1, wherein the storage controller is configured to process the data identified by the logical address as cold data through compression of the data.

6. The storage system of claim 5, wherein the compression of the data includes a transfer of the data from a first physical location at which uncompressed data is stored to a second physical location at which corresponding compressed data is stored.

7. The storage system of claim 1, wherein the storage controller is configured to process the data identified by the logical address as cold data through an increase of a data retention characteristic of a portion of the storage memory that includes the corresponding physical location comprising the data.

8. The storage system of claim 7, wherein the increase of the data retention characteristic includes a narrowing of a distribution of voltages around each state of a cell of flash memory located at the corresponding physical that comprises the data.

9. The storage system of claim 1, wherein the information received from the host includes a command received via a storage protocol that identifies a set of logical blocks as comprising cold data.

10. A computer-readable storage medium encoded with computer executable instructions, the computer executable instructions executable with a processor, the computer-readable storage medium comprising:
instructions executable to identify a set of files stored in a storage system that have a last modified date older than a threshold time period;
instructions executable to map the set of files to logical addresses that point to data belonging to the set of files in the storage system; and
instructions executable to transmit a command from a host system to the storage system that identifies the logical addresses that point to cold data on the storage system, wherein the cold data is data that has not been written to within the threshold time period.

11. The computer-readable storage medium of claim 10, wherein the command is a command in a storage protocol, wherein the storage protocol is a communications protocol used to provide block level access to a block storage device of the storage system from the host system.

12. The computer-readable storage medium of claim 10, wherein the logical addresses include logical block addresses.

13. The computer-readable storage medium of claim 10, wherein the command comprises the logical addresses that point to the cold data on the storage system.

14. A method comprising:
providing a storage memory in a storage system, wherein physical locations in the storage memory correspond to logical addresses, wherein data stored at a physical location in the storage memory is pointed to by a logical address, wherein the physical location is included in the physical locations, and wherein the logical address is included in the logical addresses;
receiving a command over a storage interface that identifies the logical address as pointing to data that has not been updated within a threshold time period; and
processing the data stored at the physical location as cold data with a storage controller based on receipt of the command over the storage interface that identifies the logical address that points to the data.

15. The method of claim 14, wherein the processing the data as cold data comprises copying the data from a first storage memory to a second storage memory, the storage memory comprising the first storage memory and the second storage memory.

16. The method of claim 14, wherein the second storage memory includes a different type of memory than the first storage memory.

17. The method of claim 14, wherein the processing the data as cold data comprises compressing the data.

18. The method of claim 17, wherein compressing the data includes transferring the data from a first physical location at which uncompressed data is stored to a second physical location at which corresponding compressed data is stored.

19. The method of claim 14, wherein the processing the data as cold data comprises increasing a data retention of a portion of the storage memory that includes the corresponding physical location that comprises the cold data.

20. The method of claim 14, wherein increasing the data retention of the portion of the storage memory comprises narrowing a distribution of voltages around each state of a cell of flash memory located at the corresponding physical that comprises the cold data.
